(19) United States
(12) Patent Application Publication
(10) Pub. No.: US 2003/0036966 A1
(43) Pub. Date: Feb. 20, 2003

(54) Computer system, method, and business method for integrating an e-commerce application with a back-end business processing application

(75) Inventors: Nadir K. Amra, Rochester, MN (US); Thomas John Eggebraaten, Rochester, MN (US); Jan Theresa Karels, Rochester, MN (US)

Correspondence Address: MARTIN & ASSOCIATES, LLC, P O BOX 548, CARTHAGE, MO, 64836-0548, US

(73) Assignee: International Business Machines Corporation, Armonk, NY

(21) Appl. No.: 09/931,555

(22) Filed: Aug. 16, 2001

(51) Int. Cl. G06F 17/60

(52) U.S. Cl. 705/26

(57) ABSTRACT

An apparatus, method, and method for doing business allow easily integrating a web-enabled front-end application with a back-end business processing application, such as a J.D. Edwards OneWorld application. The e-commerce application and the back-end business processing application each include a message queue adapter that defines inbound and outbound queues that are used to pass XML messages. An integration node is coupled to the inbound and outbound queues for the web-enabled front-end application, and is also coupled to the inbound and outbound queues for the business processing application. When the integration node receives an XML message in a first format from the front-end application, it converts the XML message to an XML message in a second format compatible with the back-end application, and sends the converted XML message to the back-end application. Similarly, the integration node converts XML messages received from the back-end application in the second format to XML messages in the first format for the front-end application. In this manner a web-enabled front-end may be easily integrated with a non-web-enabled back-end system.

### BACKGROUND OF THE INVENTION

1. Technical Field

This invention generally relates to computer communications, and more specifically relates to communications in an e-commerce environment.

2. Background Art

Since the dawn of the computer age, computer systems have evolved into extremely sophisticated devices, and computer systems may be found in many different settings. The widespread proliferation of computers prompted the development of computer networks that allow computers to communicate with each other. With the introduction of the personal computer (PC), computing became accessible to large numbers of people. Networks for personal computers were developed that allow individual users to communicate with each other.

One significant computer network that has recently become very popular is the Internet. The Internet grew out of this proliferation of computers and networks, and has evolved into a sophisticated worldwide network of computer system resources commonly known as the “world-wide-web”, or WWW. A user at an individual PC (i.e., workstation) that wishes to access the Internet typically does so using a software application known as a web browser. A web browser makes a connection via the Internet to other computers known as web servers, and receives information from the web servers that is rendered to the user's workstation. Information transmitted from the web server to the web browser is generally formatted using a specialized language called Hypertext Markup Language (HTML) and is typically organized into pages known as web pages.

Online merchants have discovered the value of selling their goods and services via the Internet. Many allow buyers to place goods in a virtual “shopping cart”, then when the buyer is prepared to finalize the purchase, they proceed to the “checkout.” At this stage, all of the items in the buyer's shopping cart are displayed with their prices, tax, shipping and handling, and a total amount due is shown to the buyer. The buyer can then enter credit card information, and pressing a “submit” button sends the credit card information to the merchant, which then authenticates the credit card and receives an authorization for the sale. Online sales are typically more efficient (and hence, less costly) than other sales methods because the customer performs the shopping functions, and submits a completed order. The fulfillment of that order can typically be done via processes already in place, so the expense of taking and entering orders is eliminated.

One common problem in e-commerce is integrating web-enabled front-ends, such as an e-commerce web site, with existing applications that manage and control business processes for a company, such as a product inventory database. One known solution to this problem is to generate custom code that allows communicating between the web-enabled front-end and the existing applications. This solution, however, is very costly, and requires a new, custom program each time the problem is encountered. Without an architected way for quickly and efficiently coupling a web-enabled front-end to a non-web-enabled back end, businesses will continue to suffer from delays and excessive expense in marketing their products via e-commerce.

### DISCLOSURE OF INVENTION

According to the preferred embodiments, an apparatus, method, and method for doing business allow easily integrating a web-enabled front-end application with a backend business processing application, such as a J. D. Edwards OneWorld application. The e-commerce application and the back-end business processing application each include a message queue adapter that defines inbound and outbound queues that are used to pass XML messages. An integration node is coupled to the inbound and outbound queues for the web-enabled front-end application, and is also coupled to the inbound and outbound queues for the business processing application. When the integration node receives an XML message in a first format from the front-end application, it converts the XML message to an XML message in a second format compatible with the back-end application, and sends the converted XML message to the back-end application. Similarly, the integration node converts XML messages received from the back-end application in the second format to XML messages in the first format for the front-end application. In this manner a web-enabled front-end may be easily integrated with a non-web-enabled back-end system.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a block diagram of a prior art networked computer system that allows a web client to interact with a web server;

FIG. 2 is a block diagram of a networked computer system in accordance with the preferred embodiments that couples an e-commerce front-end application to a back-end business processing application;

FIG. 3 is a block diagram of one specific implementation of box 210 of FIG. 2 in accordance with the preferred embodiments;

FIG. 4 is a block diagram showing details of the integration node 330 shown in FIG. 3 in accordance with the preferred embodiments;

FIG. 5 is a block diagram showing details of the XSL stylesheets 440 shown in FIG. 4 in accordance with the preferred embodiments;

FIG. 6 is a table showing the correlation between OneWorld messages and WebSphere Commerce Suite (WCS) messages, along with the XSL stylesheet used to perform the conversion between these two message formats in accordance with the preferred embodiments;

FIG. 7 is a flow diagram of a method in accordance with the preferred embodiments for a front-end e-commerce application to communicate with a OneWorld back-end business processing application;

FIG. 8 is a flow diagram of a method in accordance with the preferred embodiments for a OneWorld back-end application to update the database in the front-end e-commerce application;

FIG. 9 is a class diagram showing the classes used in accordance with the preferred embodiments;

FIG. 10 is a table showing properties that may be specified in the IntegrationNode.properties file in accordance with the preferred embodiments;

FIG. 11 is a table that shows the function of various call-back methods defined on the HandlerBase class of FIG. 9; and

FIG. 12 is a state diagram of the call-back methods defined on the HandlerBase class of FIG. 9.

### BEST MODE FOR CARRYING OUT THE INVENTION

The Internet connects millions of computers around the world. Companies that would like to sell products or services via the Internet need a way to couple existing business computer systems to an e-commerce front-end. The present invention defines an architected manner to easily couple an e-commerce front-end application to an existing non-web-enabled back-end business processing application.

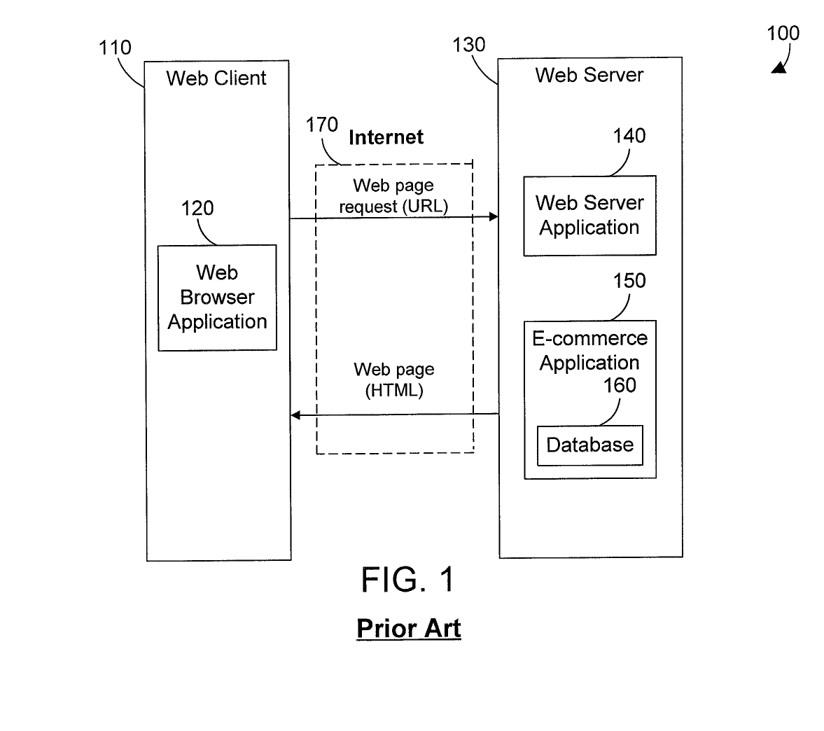

An example of a typical Internet connection is shown by the apparatus 100 in FIG. 1. A user that wishes to access information on the Internet 170 typically has a computer workstation 110 (referred to as a “web client”) that executes an application program known as a web browser 120. Under the control of web browser 120, web client workstation 110 sends a request for a web page over the Internet 170. Web page data can be in the form of text, graphics and other forms of information, collectively known as MIME data. Each web server on the Internet has a known address, termed the Uniform Resource Locator (URL), which the web browser uses to connect to the appropriate web server. Because web server 130 can contain more than one web page, the user will also specify in the address which particular web page he wants to view on web server 130. A web server computer system 130 executes a web server application 140, monitors requests, and services requests for which it has responsibility. When a request specifies web server 130, web server application 140 generally accesses a web page corresponding to the specific request, and transmits the web page to the web browser 120 on the user's workstation 110. Known web browsers include Netscape Communicator and Microsoft Internet Explorer.

A web page may contain various types of data, including MIME data. Most web pages include visual data that is intended to be displayed on the monitor of user workstation 110. Web pages are generally written in Hypertext Markup Language (HTML). When web server 130 receives a web page request, it will send the requested web page in HTML form across the Internet 170 to the requesting web browser 120. Web browser 120 understands HTML and interprets it and outputs the web page to the monitor (or display) of user workstation 110. This web page displayed on the user's screen may contain any suitable MIME data, including text, graphics, audio elements, video elements, and links (which reference addresses of other web pages). These other web pages (i.e., those represented by links) may be on the same or on different web servers. The user can invoke these other web pages by clicking on these links using a mouse or other pointing device. This entire system of web pages with links to other web pages on other servers across the world is known as the “World Wide Web”.

Some web servers may include an e-commerce application 150 that allows on-line customers to purchase goods or services. E-commerce application 150 typically includes a database 160 that contains the list of registered customers, products/services offered, etc. The problem with having an e-commerce application 150 with its own database 160 is that these are separate and distinct from traditional, non-web-enabled back-end business processing systems that a company may already have in place. There is currently no simple way to integrate an e-commerce application 150 to an existing non-web-enabled back-end business processing system.

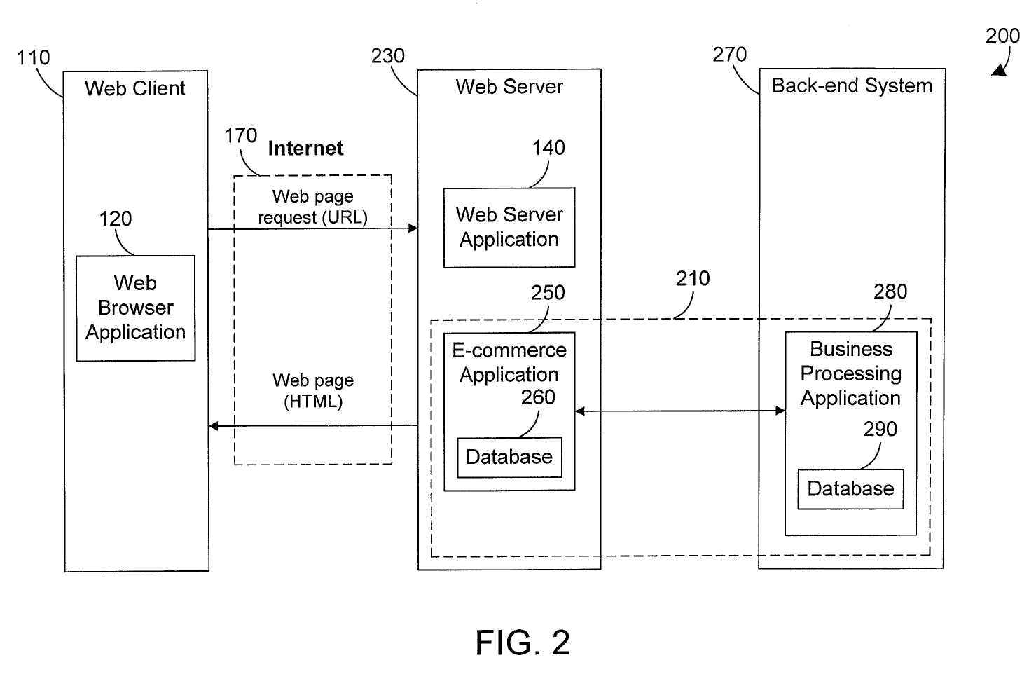

Referring to FIG. 2, a networked computer system 200 in accordance with the preferred embodiments includes a web browser 120 running on a first computer system 110, as in the prior art. Note, however, that web server 230 includes an e-commerce application 250 that is coupled to a business processing application 280 in a back-end computer system 270. Business processing application 280 includes its own database 290. The problem solved by the preferred embodiments is providing an interface that allows the easy integration of e-commerce application 250 to back-end processing application 280, and that allows easily synchronizing data in the e-commerce database 260 and the back-end database 290. The embodiments described herein with reference to the figures assume that e-commerce application 250 is running on one computer system 230, and business processing application 280 is running on a separate computer system 270. Note, however, that the separate computer systems may actually be different partitions on the same physical computer system within the scope of the preferred embodiments. Thus, a single computer system could perform the functions of computer systems 230 and 280 in FIG. 2. With this in mind, the first and second computer systems shown in the figures and discussed in the claims expressly extend to first and second partitions on the same computer system.

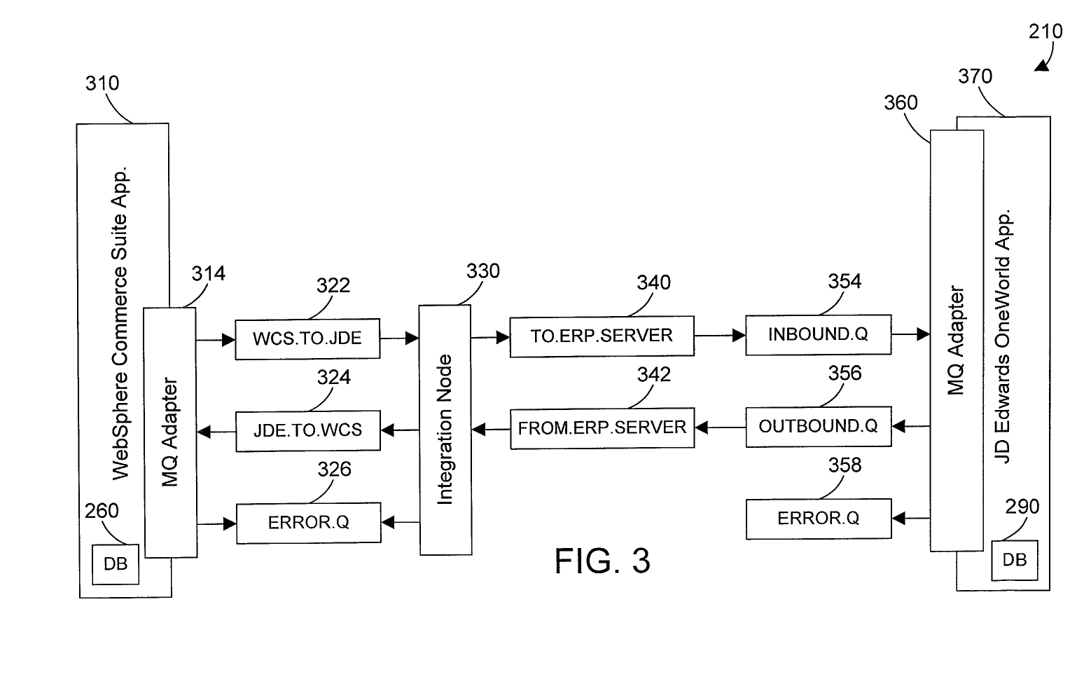

Referring now to FIG. 3, one specific embodiment for box 210 in FIG. 2 includes an application 310 implemented using WebSphere Commerce Suite version 4.1 (WCS). WebSphere Commerce Suite is a trademark of International Business Machines Corporation. WCS application 310 includes a message server known as a message queue (MQ) adapter 314. MQ adapter 314 provides queues that are used to pass messages to and from WCS application 310. Examples of suitable queues are WCS.TO.JDE queue 322, JDE.TO.WCS queue 324, and ERROR.Q queue 326. JDE.TO.WCS queue 324 receives messages intended for WCS application 310. WCS.TO.JDE queue 322 receives messages written by WCS application 310. ERROR.Q queue 326 is used to store error messages that may be written by WCS application 310 or integration node 330. WCS application 310 suitably includes a first database 260 that includes customer and product information. General information regarding IBM WebSphere Commerce Suite may be found at http://www-4.ibm.com/software/webservers/commerce.

One suitable implementation of a back-end business processing system is an application 370 implemented using J. D. Edwards OneWorld. Note that OneWorld is a trademark of J. D. Edwards & Company. OneWorld application 370 can also include a message server known as a message queue (MQ) adapter 360 that defines queues that are used to pass messages to and from OneWorld application 370. Examples of suitable queues are INBOUND.Q 354, OUTBOUND.Q 356, and ERROR.Q 358. INBOUND.Q queue 354 receives messages intended for OneWorld application 370. OUTBOUND.Q queue 356 receives messages written by OneWorld application 370. ERROR.Q 358 is used to store error messages that may be written by OneWorld application 370. General information regarding J. D. Edwards OneWorld may be found at http://wwwjdedwards.com.

If the message format for WebSphere Commerce Suite and J. D. Edwards OneWorld were compatible, one could simply couple the queues defined on MQ adapter 314 to the corresponding queues defined on MQ adapter 360. Note, however, that the format of messages defined in WebSphere Commerce Suite is different than the format of messages defined in J. D. Edwards OneWorld. For this reason, conversion between message formats is required.

In the preferred embodiments, an integration node 330 receives messages from the WCS.TO.JDE queue 322 in a first format (defined by WebSphere Commerce Suite), converts the messages to a second format (defined by OneWorld), and sends the messages through an intermediate queue TO.ERP.SERVER 340 that passes the messages to the INBOUND.Q queue 354. Note that “ERP” in this context means Enterprise Resource Planning, which is one suitable function performed by a back-end business processing application such as OneWorld application 370. The integration node 330 receives messages from the J. D. Edwards OneWorld application 370 in the second format via OUTBOUND.Q queue 356 and FROM.ERP.SERVER queue 342, converts the message in the second format to a message in the first format, and sends the converted message to the WebSphere Commerce Suite application 310 via JDE.TO.WCS queue 324. Note that integration node 330 may also place an error message on the ERROR.Q queue 326 if an invalid message is received.

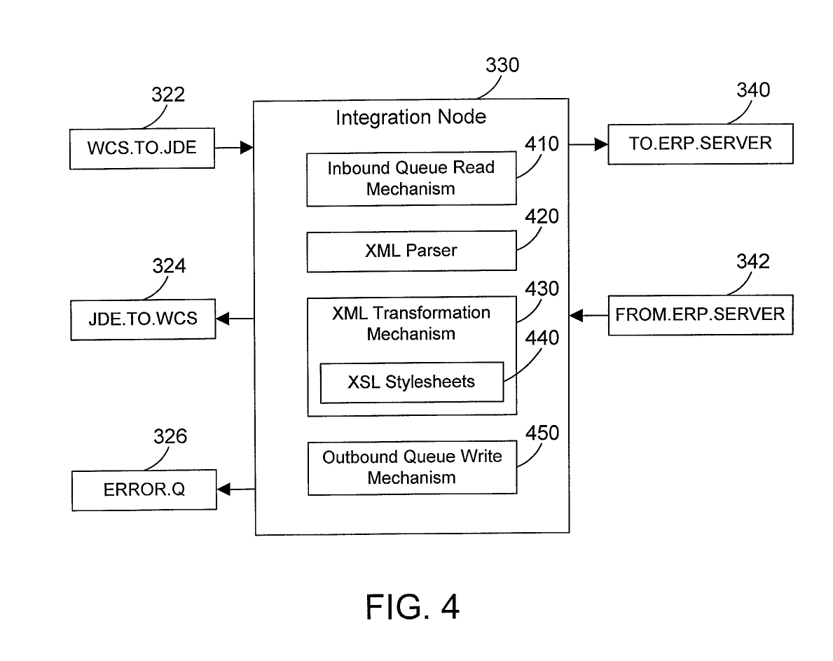

In the preferred embodiments, the messages sent and received by MQ adapter 314 in WCS application 310 are XML messages, and the messages sent and received by MQ adapter 360 in OneWorld application 370 are also XML messages. Note, however, that the format of these XML messages differs. For this reason, the integration node 330 is provided to provide a conversion between the different XML formats. Referring now to FIG. 4, the integration node 330 preferably includes an inbound queue read mechanism 410, an XML parser 420, an XML transformation mechanism 430, and an outbound queue write mechanism 450. When an XML message in WCS format is written to WCS.TO.JDE queue 322, the inbound queue read mechanism 410 reads the XML message; the XML parser 420 parses the XML message; the XML transformation mechanism 430 converts the XML message to a corresponding XML message in a different format compatible with J. D. Edwards OneWorld, and the outbound queue write mechanism 450 writes the converted message to the TO.ERP.SERVER queue 340. In similar fashion, when an XML message in J. D. Edwards OneWorld format is written to FROM.ERP.SERVER queue 342, the inbound queue read mechanism 410 reads the XML message; the XML parser 420 parses the XML message; the XML transformation mechanism 430 converts the XML message to a corresponding XML message in a different format compatible with WebSphere Commerce Suite, and the outbound queue write mechanism 450 writes the converted message to the JDE.TO.WCS queue 324. If the integration node cannot interpret part of an XML message, it will place an error message on the ERROR.Q queue 326.

The XML transformation mechanism 430 performs the conversion between WCS format and OneWorld (i.e., JDE) format using XSL stylesheets 440. XSL stylesheets 440 indicate how to convert a message in WCS format to an equivalent message in OneWorld format, and how to convert a message in OneWorld format to an equivalent message in WCS format. The stylesheets 440 work by telling the integration node 330 the mapping between XML tags in one format and XML tags in a different format.

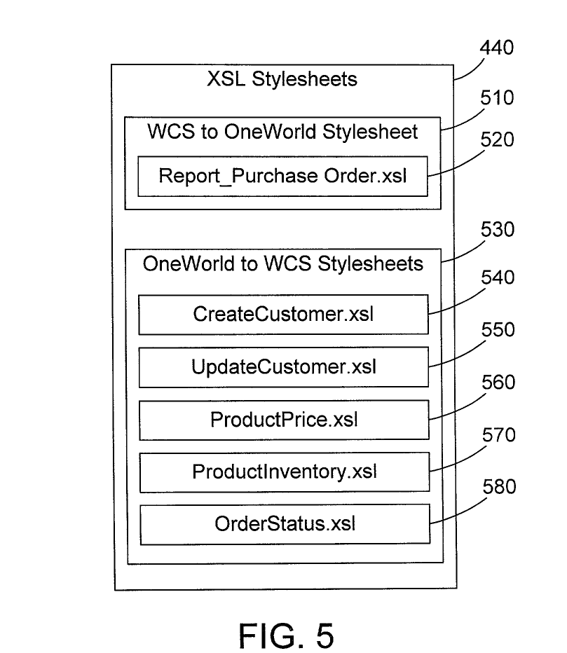

In the preferred embodiments, different stylesheets are used to convert each type of message. Referring to FIG. 5, XSL stylesheets 440 include one WCS to OneWorld stylesheet 510, namely Report_Purchase_Order.xsl 520, and five OneWorld to WCS stylesheets 530, namely CreateCustomer.xsl 540, UpdateCustomer.xsl 550, ProductPrice.xsl 560, ProductInventory.xsl 570, and OrderStatus.xsl 580. The WCS to OneWorld stylesheet 510 is used to convert one type of message that is sent from WCS to a corresponding message in OneWorld format. Similarly, the OneWorld to WCS stylesheets 530 are used to convert five types of messages that are sent from OneWorld to corresponding messages in WCS format.

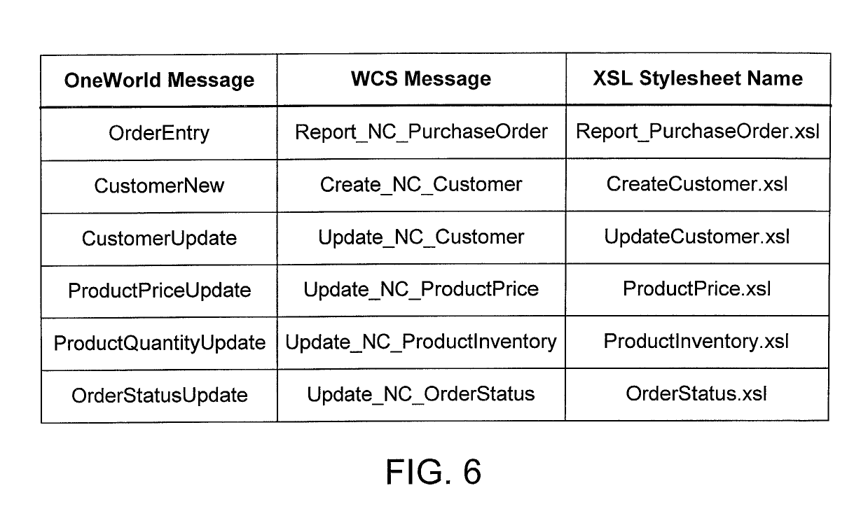

FIG. 6 shows a table that indicates the correspondence between OneWorld messages and WCS messages, and that indicates the XSL stylesheet used to make the conversion between the two message formats. Thus, the Report_NC_PurchaseOrder message in WCS format may be converted to the corresponding OrderEntry message in OneWorld format using the Report_PurchaseOrder.xsl stylesheet. The CustomerNew message in OneWorld format may be converted to the corresponding Create_NC_Customer message in WCS format using the CreateCustomer.xsl stylesheet. The CustomerUpdate message in OneWorld format may be converted to the corresponding Update_NC_Customer message in WCS format using the UpdateCustomer.xsl stylesheet. The ProductPriceUpdate message in OneWorld format may be converted to the corresponding Update_NC_ProductPrice message in WCS format using the ProductPrice.xsl stylesheet. The ProductQuantityUpdate message in OneWorld format may be converted to the corresponding Update_NC_ProductInventory message in WCS format using the ProductInventory.xsl stylesheet. The OrderStatusUpdate message in OneWorld format may be converted to the corresponding Update_NC_OrderStatus message in WCS format using the OrderStatus.xsl stylesheet. Note that the preferred embodiments disclosed in the figures include a different stylesheet for converting each message type from one format to a different format. However, the preferred embodiments expressly include to any suitable number of stylesheets for converting messages from a first format to a second format.

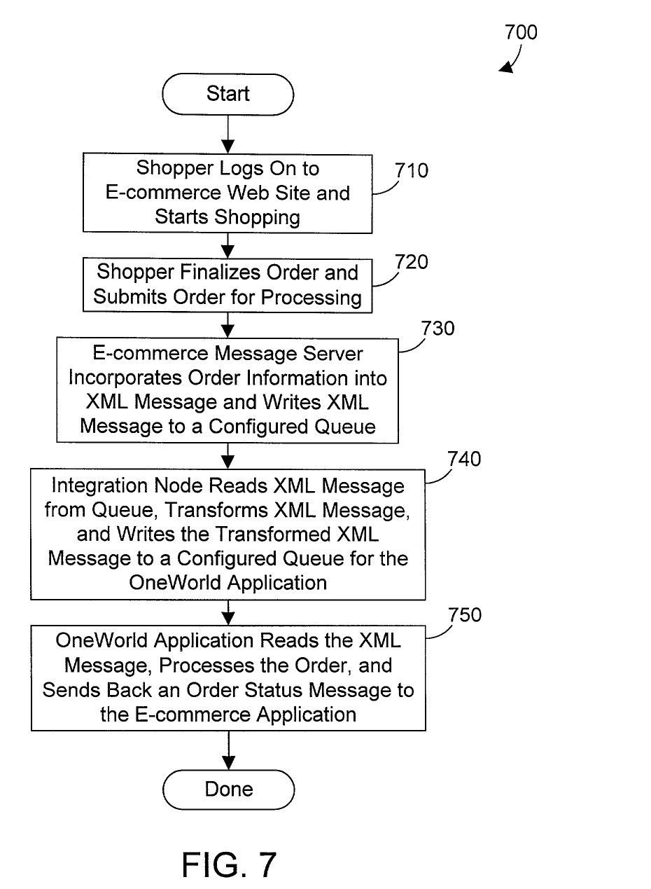

Referring now to FIG. 7, a method 700 in accordance with the preferred embodiment begins when a shopper logs on to an e-commerce web site that is running the e-commerce application (see 250 of FIG. 2) and starts shopping (step 710). We assume that the shopper finalizes the order and submits the order for processing (step 720). A message server in the e-commerce application incorporates the order information into an XML message and writes the XML message to a configured queue (step 730). The integration node reads the message from the queue, transforms the message from the first format to the second format (preferably using an XSL stylesheet), and writes the transformed message to a configured queue for the OneWorld application (step 740). The OneWorld application then reads the XML message from the queue, processes the order that is within the XML message, and sends back an order status message to the e-commerce application (step 750).

The flow of method 700 may be best understood by referring to FIG. 3. Steps 710 and 720 are performed by a user interacting with the WCS application 310. In step 730, the MQ adapter 314 writes an XML message Report_NC_PurchaseOrder in WCS format to the WCS.TO.JDE queue 322. In step 740, the integration node 330 reads the Report_NC_PurchaseOrder message from the WCS.TO.JDE queue 322, uses the Report_PurchaseOrder.xsl stylesheet to convert the Report_NC_PurchaseOrder message to the corresponding OrderEntry message in OneWorld format (see FIG. 6), and writes the OrderEntry message in OneWorld format to the TO.ERP.SERVER queue 340. This OrderEntry message is then written to INBOUND.Q queue 354, and step 750 reads the OrderEntry message, processes the order contained in the OrderEntry message, and sends a status message back to the WCS application 310.

The OneWorld application 370 to sends messages to the WCS application 310 by writing a messages such as an OrderStatusUpdate message in OneWorld format to the OUTBOUND.Q queue 356. The OrderStatusUpdate message is then written to the FROM.ERP.SERVER queue 342. The integration node 330 reads the OrderStatusUpdate message from the FROM.ERP.SERVER queue, uses the OrderStatus.xsl stylesheet to convert the OrderStatusUpdate message to a corresponding Update NC_OrderStatus message in WCS format (see FIG. 6), and writes the Update_NC_OrderStatus message to the JDE.TO.WCS queue 324. The MQ adapter 314 then reads the Update NC_OrderStatus message from the JDE.TO.WCS queue 324, and determines from this message whether the order entry was processed correctly or not.

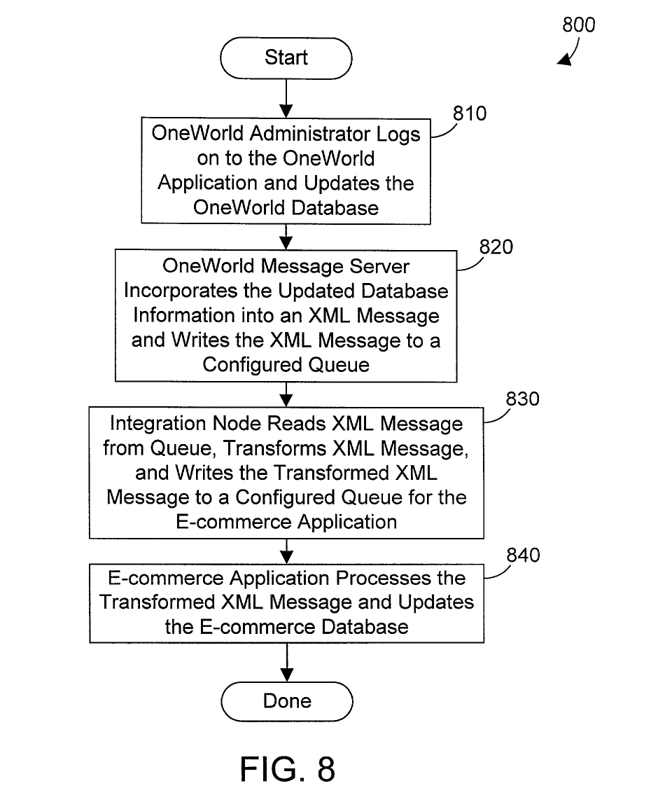

Referring back to FIGS. 2 and 3, one problem with integrating an e-commerce application 250 with an existing back-end business processing application 280 is keeping the information in the e-commerce database 260 consistent with the information in the back-end database 290. FIG. 8 illustrates a method 800 for synchronizing information in the e-commerce database 260 and the back-end database 290. The example in FIG. 8 applies to updating any information in the e-commerce database from changes in the OneWorld database, such as changing product quantity, creating new customers, updating customer information, updating product prices, etc. For the specific example of FIG. 8, the OneWorld administrator logs onto the OneWorld application and updates the OneWorld database (step 810). The OneWorld message server incorporates the updated database information into an XML message and writes the XML message to a configured queue (step 820). The integration node reads the XML message in OneWorld format from the queue, transforms the XML message to a corresponding XML message in WCS format, and writes the transformed XML message to a configured queue for the e-commerce application (step 830). The e-commerce application then reads the XML message from the queue, processes the message, and updates the e-commerce database according to the information in the message (step 840). Note that the flow described in method 800 assumes that changes to the OneWorld database 290 are propagated to the e-commerce database 260. However, the preferred embodiments also extend to the opposite case, when changes to e-commerce database 260 are propagated to the OneWorld database 290.

Method 800 of FIG. 8 may be best understood with reference to FIG. 3 for the specific example of a change of product quantity. In step 810, the system administrator logs on to the OneWorld application and updates the quantity of a product in the OneWorld database 290. In step 820, the MQ adapter 360 incorporates the changed product quantity into a ProductQuantityUpdate message that it writes to the OUTBOUND.Q queue 356. The message is then written to the FROM.ERP.SERVER queue 342. Step 830 reads the ProductQuantityUpdate message from the FROM.ERP.SERVER queue 342, uses the ProductInventory.xsl stylesheet to convert the ProductQuantityUpdate message in OneWorld format to a corresponding Update_NC_ProductInventory message in WCS format, and writes the Update_NC_ProductInventory message to the JDE.TO.WCS queue 324. The MQ adapter 314 then reads the Update_NC_ProductInventory message from the JDE.TO.WCS queue 324, and step 840 processes the Update_NC_ProductInventory message and updates the WCS database 260 with the updated product inventory information. Of course, method 800 may also be used to create new customers, update customer information, and update the price of a product residing in the WCS database 260. Method 800 thus provides a way to easily synchronize the data in WCS database 260 and OneWorld database 290. While method 800 refers to a system administrator making manual changes to OneWorld database 290, the preferred embodiments expressly include any changes to either the WCS database 260 or the OneWorld database 290, whether made by a human user or by a computer program.

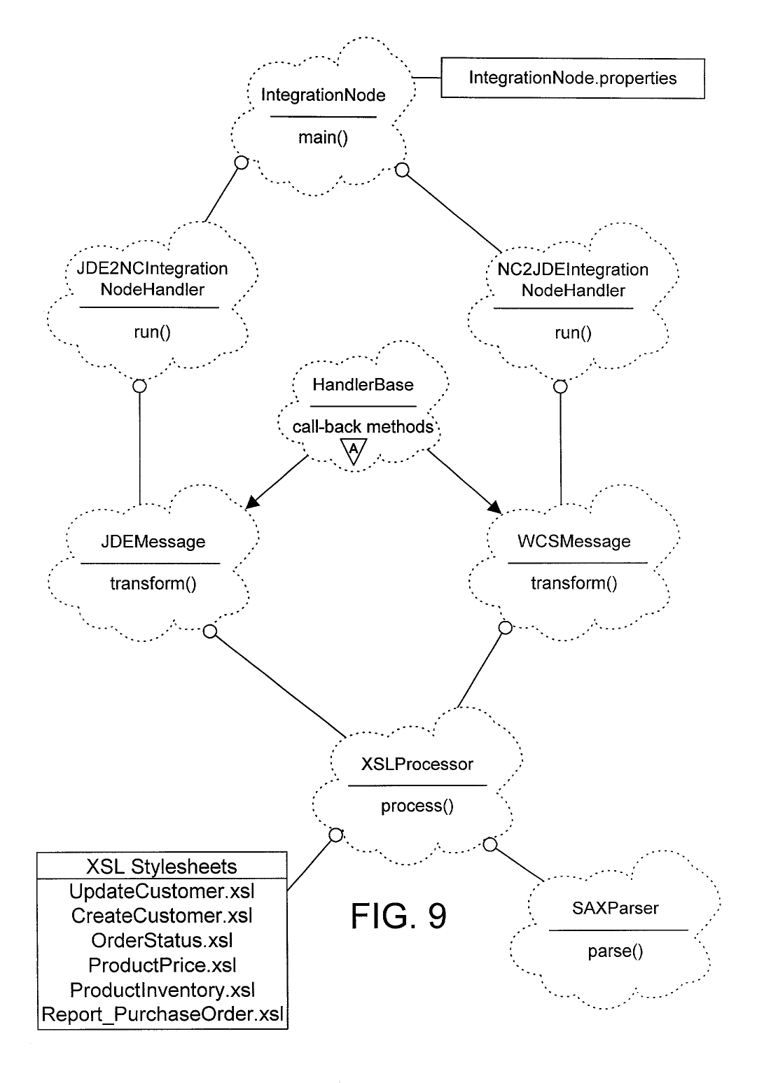

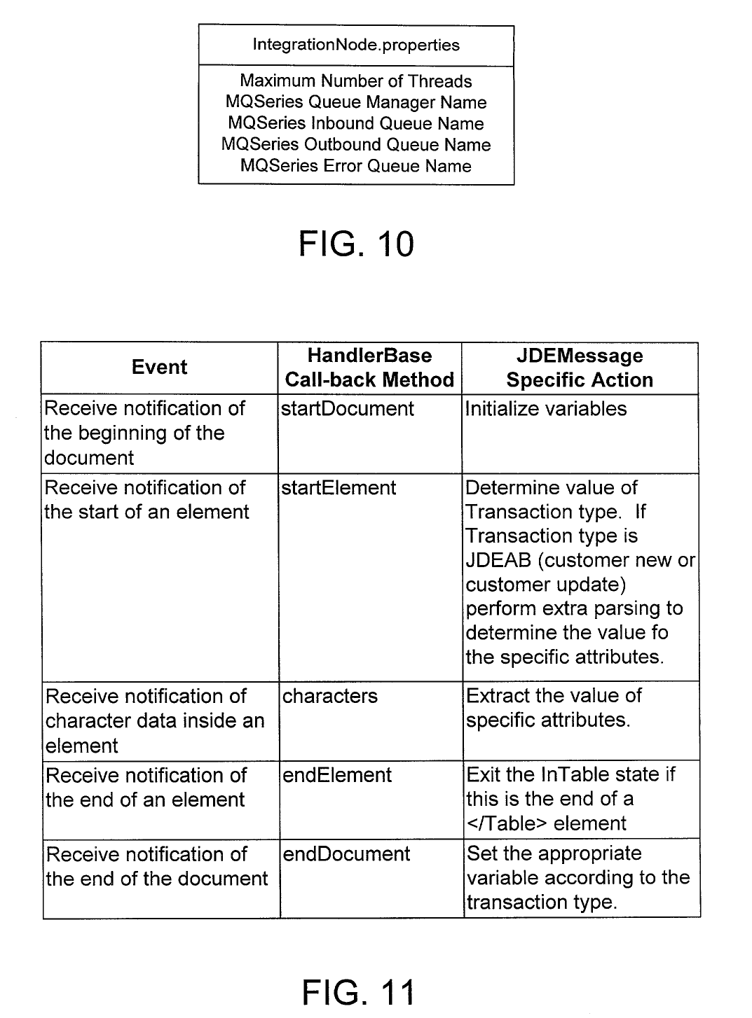

Referring to FIG. 9, the classes that are needed to implement the preferred embodiments are shown in Booch notation. The IntegrationNode class includes a main( ) method that is invoked to begin execution of the integration node, and which invokes the run( ) methods on the JDE2NCIntegrationNodeHandler class and the NC2JDEIntegrationNodeHandler class. The IntegrationNode class functions according to properties specified in an IntegrationNode.properties file. This allows the function of the IntegrationNode class to be dynamically changed by writing new values to the IntegrationNode.properties file without requiring re-compilation of the IntegrationNode class. Some suitable properties that may be specified in the IntegrationNode.properties file are shown in FIG. 10, and include: maximum number of threads; MQSeries Queue Manager Name; MQSeries Inbound Queue Name; MQSeries Outbound Queue Name; and MQSeries Error Queue Name.

The IntegrationNode class uses two classes, namely the JDE2NCIntegrationNodeHandler class, and the NC2JDEIntegrationNodeHandler class. The JDE2NCIntegrationNodeHandler class uses a JDEMessage class that is a subclass of a HandlerBase abstract class that includes call-back methods that are implemented in the subclasses to perform desired functions. The JDEMessage class includes a transform( ) method that is invoked to transform a message in OneWorld format to a corresponding message in WCS format. The JDEMessage class uses the XSLProcessor class to process a OneWorld message. XSLProcessor includes a process( ) method that processes an XML message using one or more XSL stylesheets, such as those shown in FIG. 9. The XSLProcessor class uses the SAXParser class, which includes a parse( ) method for parsing an XML message. The WCSMessage class is a subclass of the HandlerBase class, and implements the call-back methods in HandlerBase. The transform( ) method on the WCSMessage class is invoked to transform a message in WCS format to a corresponding message in OneWorld format. Note that WCSMessage also uses the XSLProcessor class to transform the message in WCS format to a corresponding message in OneWorld format according to one or more XSL stylesheets.

FIG. 11 is a table that shows various call-back methods in the HandlerBase class that are overridden in the JDEMessage class to add the required logic to process a OneWorld XML message (such as the CustomerNew message in FIG. 11). When the SAXParser detects one of the predefined events, it calls the corresponding method in JDEMessage to implement the required function. Thus, when SAXParser receives notification of the beginning of the document, it invokes the startDocument( ) method on the JDEMessage class, which initializes the variables in the document. When the SAXParser receives notification of the start of an element, in invokes the startElement( ) method on the JDEMessage class, which determines the value of the transaction type. When the SAXParser receives notification of character data inside an element, it invokes the characters( ) method on the JDEMessage class, which extracts the value for the specific attributes. When the SAXParser receives notification of an end of an element, it invokes the endElement( ) method on the JDEMessage class, which exits the InTable state if the endElement( ) method signals the end of a table element. When the SAXParser receives notification of the end of the document, it invokes the endDocument( ) method on the JDEMessage class, which sets the appropriate variable according to the transaction type. In this manner, overriding the call-back methods defined on the HandlerBase class with appropriate logic in the JDEMessage class results in logic that performs the conversion of an XML message in OneWorld format to a corresponding XML message in WCS format.

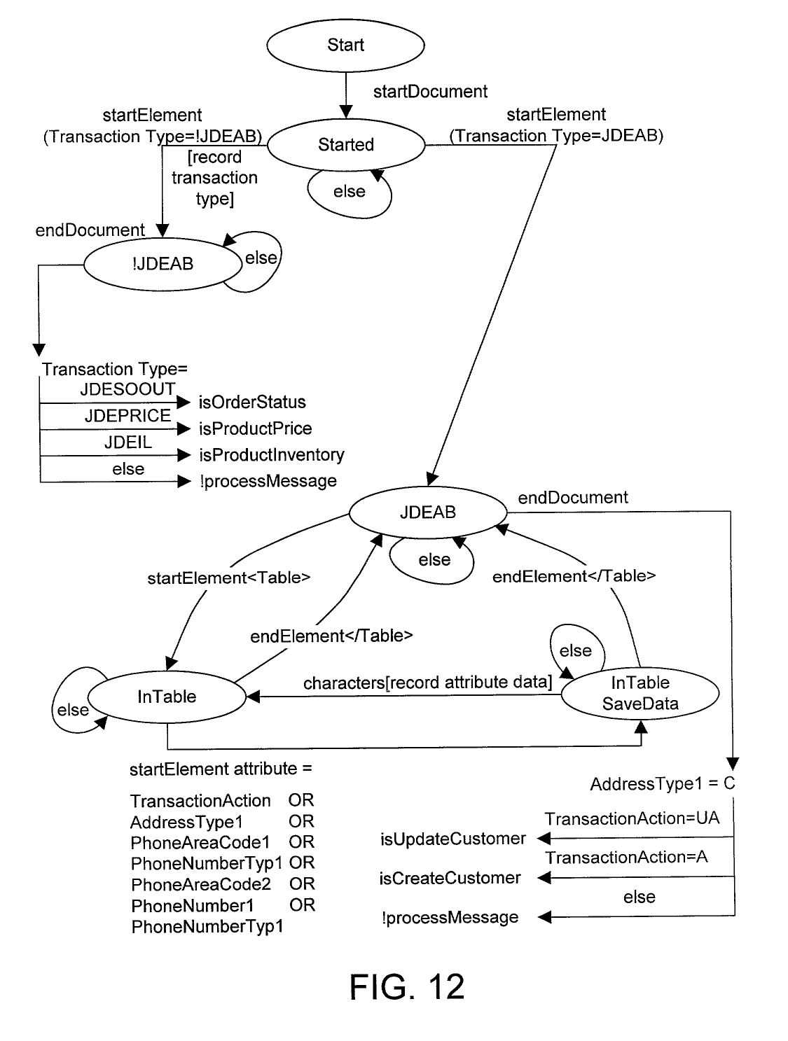

FIG. 12 is a state diagram of the call-back methods on the JDEMessage class. The startDocument( ) method must be invoked to exit the Start state and go to the Started state, and only occurs when the SAXParser receives notification of the beginning of the document. Once the Started state is entered, a startElement( ) method must be invoked, which occurs when the SAXParser receives notification of the start of an element. The path out of the Started state depends on the transaction type. If the Transaction Type is not JDEAB, the state goes from Started to !JDEAB. At this point, the parser waits for an indication of the end of the document. If the transaction type is JDESOUT, the transaction is an OrderStatus transaction, which means that the OneWorld XML message being processed is an OrderStatusUpdate message. If the transaction type is JDEPRICE, the transaction is a ProductPrice transaction, which means that the OneWorld XML message being processed is a ProductPriceUpdate message. If the transaction type is JDEIL, the transaction is a ProductInventory transaction, which means that the OneWorld XML message being processed is a ProductQuantityUpdate message. If the transaction type is neither JDESOUT, JDEPRICE, nor JDEIL, the XML message is invalid, and the message is placed on the ERROR.Q queue 358 (i.e., !processMessage in FIG. 12).

If when in the Started state, the startElement has a transaction type of JDEAB, the state passes to the JDEAB state. In this state, the start of a table element (e.g., startElement<Table>) will result in entering the InTable state. If the value of the startElement attribute is TransactionAction, AddressType1, PhoneAreaCode1, PhoneNumberTyp1, PhoneAreaCode2, PhoneNumber1, or PhoneNumberTyp1, the state passes to the InTableSaveData state. If there are characters to record in the table, the characters [record attribute data] results in a transition to the InTable state. If an endElement</Table> tag is processed in the InTableSaveData state, the state transitions to the JDEAB state. Similarly, if an endElement</Table> tag is processed in the InTable state, the state transitions to the JDEAB state. When in the JDEAB state, an endDocument results in exiting the JDEAB state. If the AddressType1=C, this means that the update is for a customer. Note that the back-end database may contain employee information as well as customer information, so the AddressType1 field is used to distinguish between an employee update and a customer update. Assuming that AddressType1=C (meaning that the update is for a customer), the value of the transaction action in the XML message will determine what action to take. If the TransactionAction=UA, the message is an update customer transaction, which means that the OneWorld XML message being processed is a CustomerUpdate message. If the TransactionAction=A, the message is a create customer transaction, which means that the OneWorld XML message being processed is a CustomerNew message. If the TransactionAction has any value besides UA or A, the message is placed on the ERROR.Q queue 358 (i.e., !processMessage).

The drawings herein show specific examples of networked computer systems and computer-implemented methods in accordance with the preferred embodiments. One skilled in the art will appreciate that the computer-implemented methods could also be used as a method for doing business, and that the integration node 330 of FIG. 3 could be distributed as a computer-readable program product that may include both recordable media and transmission media. The preferred embodiments expressly extend to networked computer system, computer-implemented methods, methods for doing business, and program products that are within the scope of the disclosure herein and a reasonable range of equivalents.

The preferred embodiments disclosed herein provide a way for an e-commerce application to easily interface with an existing back-end business processing application using XML messages that are translated between different formats by an integration node. By providing an architected manner for web-enabled front-end applications to interact with non-web-enabled back-end business processing applications, companies will be able to more quickly provide an e-commerce solution to offer goods or services to their customers via the world wide web.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

We claim:

1. A networked computer system comprising:
(A) a first computer system comprising an e-commerce application;
(B) a second computer system coupled to the first computer system, the second computer system comprising a back-end business processing system;
(C) an integration node coupled to the first and second computer systems, the integration node receiving messages in a first format from the e-commerce application, converting the messages in the first format to messages in a second format, and sending the messages in the second format to the back-end business processing application.

2. The networked computer system of claim 1 wherein the first computer system comprises:
a first queue for sending messages to the integration node; and
a second queue for receiving messages from the integration node.

3. The networked computer system of claim 1 wherein the second computer system comprises:
a first queue for sending messages to the integration node; and
a second queue for receiving messages from the integration node.

4. The networked computer system of claim 1 wherein the integration node receives messages in the second format from the back-end business processing application, converts the messages in the second format to messages in the first format, and sends the messages in the first format to the e-commerce application.

5. The networked computer system of claim 1 wherein the integration node uses at least one XSL stylesheet to convert the messages in the first format to the messages in the second format.

6. The networked computer system of claim 1 wherein the messages comprise XML messages, and wherein the integration node comprises:
an inbound queue read mechanism that reads information from at least one inbound queue;
an XML parser that processes the XML messages;
an XML transformation mechanism that converts an XML message in the first format to a corresponding XML message in the second format, and that converts an XML message in the second format to a corresponding XML message in the first format; and
an outbound queue write mechanism that writes at least one converted XML message to an outbound queue.

7. The networked computer system of claim 1 wherein the e-commerce application comprises an application implemented using IBM WebSphere Commerce Suite.

8. The networked computer system of claim 1 wherein the back-end business processing application comprises an application implemented using J. D. Edwards One World.

9. The networked computer system of claim 1 further comprising a mechanism for synchronizing data in a first database accessed by the e-commerce application with data in a second database accessed by the back-end business processing application.

10. A networked computer system comprising:
(A) a first computer system comprising:
an e-commerce application implemented using IBM WebSphere Commerce Suite;
a first message queue adapter that communicates with the e-commerce application, the first message queue adapter comprising:
a first queue for outbound messages;
a second queue for inbound messages;
(B) a second computer system comprising:
a J. D. Edwards One World business processing application;
a second message queue adapter that communicates with the business processing application, the second message queue adapter comprising:
a first queue for outbound messages;
a second queue for inbound messages;
(C) an integration node coupled to the first and second queues of the first message queue adapter, and coupled to the first and second queues of the second message queue adapter, wherein the integration node receives messages in a first format from the e-commerce application via the first queue of the first message queue adapter, converts the messages in the first format to messages in a second format, and sends the messages in the second format to the business processing application via the second queue of the second message queue adapter.

11. The networked computer system of claim 10 wherein the integration node receives messages in a second format from the business processing application via the first queue of the second message queue adapter, converts the message in the second format to messages in the first format, and sending the messages in the first format to the e-commerce application via the second queue of the first message queue adapter.

12. A method for communicating between an e-commerce application in a first computer system and a back-end business processing application in a second computer system, the method comprising the steps of:
(A) the e-commerce application formatting an XML message in a first format;
(B) processing the XML message in the first format, and generating therefrom a corresponding XML message in a second format; and
(C) sending the corresponding XML message in the second format to the back-end business processing application.

13. The method of claim 12 further comprising the step of:
(D) the back-end business processing application processing the corresponding XML message in the second format to perform business processing specified in the corresponding XML message in the second format.

14. The method of claim 13 further comprising the step of:
(E) the back-end business processing application sending a status message to the e-commerce application indicating the success or failure of processing the corresponding XML message in the second format.

15. The method of claim 12 wherein step (A) comprises the steps of:
(A1) the e-commerce application sending a message to a message server;
(A2) in response to the message received from the e-commerce application, the message server formatting the XML message in the first format;
(A3) the message server writing the XML message in the first format to a queue.

16. The method of claim 12 wherein step (B) comprises the steps of:
(B1) reading the XML message in the first format from a queue that is written to by the e-commerce application;
(B2) parsing the XML message in the first format;
(B3) transforming the XML message in the first format to the XML message in the second format using at least one XSL stylesheet; and
(B4) writing the XML message in the second format to a queue that is read by the back-end business processing application.

17. The method of claim 12 wherein step (C) comprises the step of the back-end business processing application reading the XML message in the second format from a queue.

18. The method of claim 12 wherein step (B) is performed by an integration node that is coupled to the e-commerce application in the first computer system and that is coupled to the back-end business processing application in the second computer system.

19. The method of claim 12 wherein the e-commerce application comprises an application implemented using IBM WebSphere Commerce Suite.

20. The method of claim 12 wherein the business processing application comprises an application implemented using J. D. Edwards One World.

21. The method of claim 12 further comprising the step of synchronizing data in a first database coupled to the e-commerce application with data in a second database coupled to the back-end business processing application.

22. A method for communicating between an e-commerce application implemented using IBM WebSphere Commerce Suite running on a first computer system and a business processing application implemented using J. D. Edwards OneWorld running on a second computer system, the method comprising the steps of:
(A) the e-commerce application sending a message to a first message server;
(B) in response to the message received from the e-commerce application, the first message server formatting an XML message in a first format;
(C) the first message server writing the XML message in the first format to a first queue;
(D) reading the XML message in the first format from the first queue;
(E) parsing the XML message in the first format;
(F) transforming the XML message in the first format to an XML message in a second format using at least one XSL stylesheet;
(G) writing the XML message in the second format to a second queue;
(H) a second message server reading the XML message in the second format from the second queue; and
(I) the second message server sending the XML message in the second format to the back-end business processing application.

23. The method of claim 22 further comprising the step of:
(J) the back-end business processing application reading the XML message in the second format; and
(K) the back-end business processing application performing business processing specified in the XML message in the second format.

24. The method of claim 23 further comprising the step of:
(L) the back-end business processing application sending a status message to the e-commerce application indicating the success or failure of processing the XML message in the second format.

25. A method for doing business comprising the steps of:
(A) providing a networked computer system comprising:
(A1) a first computer system comprising an e-commerce application;
(A2) a second computer system coupled to the first computer system, the second computer system comprising a back-end business processing system; and
(A3) an integration node coupled to the first and second computer systems, the integration node receiving messages in a first format from the e-commerce application, converting the messages in the first format to messages in a second format, and sending the messages in the second format to the back-end business processing application;
(B) entering an order in the e-commerce application;
(C) formatting an XML message in the first format that includes information from the order entered in step (B);
(D) the integration node converting the XML message in the first format to a corresponding XML message in the second format;
(E) the back-end business processing application creating an order as specified in the XML message in the second format.

26. A computer-readable program product comprising:
(A) an integration node that reads and writes messages to first and second queues that couple the integration node to first and second computer systems, respectively, wherein the integration node receives a message in a first format from an e-commerce application via the first queue, converts the message in the first format to a corresponding message in a second format, and sends the message in the second format to a back-end business processing application;
(B) signal bearing media bearing the integration node.

27. The computer-readable program product of claim 26 wherein the signal bearing media comprises recordable media.

28. The computer-readable program product of claim 26 wherein the signal bearing media comprises transmission media.

29. The computer-readable program product of claim 26 wherein the integration node reads and writes messages to third and fourth queues that couple the integration node to the first and second computer systems, respectively, wherein the integration node receives a messages in a second format from the business processing application via the fourth queue, converts the message in the second format to a message in the first format, and sends the message in the first format to the e-commerce application via the third queue.
